(19) United States
(12) Patent Application Publication
(10) Pub. No.: US 2015/0369665 A1
(43) Pub. Date: Dec. 24, 2015

(54) MULTI BACKEND ULTRA-BROADBAND DISPERSIVE SPECTROMETER

(71) Applicant: TORNADO SPECTRAL SYSTEMS INC., Toronto (CA)

(72) Inventors: Arsen R. Hajian, Brookline, MA (US); Jeffrey T. Meade, Yellowknife (CA); Bradford B. Behr, Silver Spring, MD (US); Andrew T. Cenko, Huntingdon Valley, PA (US)

(73) Assignee: Tornado Spectral Systems Inc., Toronto, ON (CA)

(21) Appl. No.: 14/765,005

(22) PCT Filed: Jan. 31, 2014
(86) PCT No.: PCT/CA2014/000073

§ 371 Date: Jul. 31, 2015

Related U.S. Application Data
(60) Provisional application No. 61/759,829, filed on Feb. 1, 2013.

(51) Int. Cl. G01J 3/28; G01J 3/18; G01J 3/36

(52) U.S. Cl. CPC G01J 3/2803; G01J 3/36; G01J 3/18

(57) ABSTRACT

Various embodiments of systems and methods are described herein that can be used for obtaining large bandwidth, high resolution spectral images in a single snapshot by using multiple detection stages that operate in different wavelength ranges and are coupled in a branch-like fashion.

### CROSS-REFERENCE TO RELATED APPLICATION

This application claims the benefit of U.S. Provisional Patent Application No. 61/759,829, filed Feb. 1, 2013; the entire contents of Patent Application No. 61/759,829 are hereby incorporated by reference.

### FIELD

The various embodiments described herein generally relate to a system and method for broadband spectrometry.

### BACKGROUND

Two important characteristics of a spectrometer are its spectral dispersion and total bandwidth. Typically these two characteristics are inversely proportional to one another in a dispersive spectrometer due to there being a limited area on the focal plane of the detection element. Accordingly, if one wishes to obtain high spectral dispersion, and therefore good spectral resolution, the total bandwidth collected by the detector is small. However, obtaining high spectral resolution over a large bandwidth is highly desirable for numerous applications. In order to achieve this goal, current conventional spectrometers have one or more dispersive elements that scan and/or swap in time. For instance, a spectrometer may use a grating that rotates on a mechanical stage to alter the angle of incidence of the light beam hitting the grating, which changes the range of wavelengths (i.e. bandpass) which falls upon the light-detecting sensor. In another example, a spectrometer may have two or more gratings mounted in a rotating turret or wheel, wherein the different gratings have different dispersive characteristics (groove frequency, blaze angle, or reflective coating). By rotating the turret or wheel, different gratings can be placed into the light beam one at a time to direct a specific wavelength range towards the sensor. However, these are not desirable methods of data collection for high speed applications, such as when a target is moving quickly relative to the instrument, because only a single grating can be used at one time and the different wavelength coverage regions are not measured simultaneously.

### SUMMARY OF VARIOUS EMBODIMENTS

The following introduction is provided to introduce the reader to the more detailed discussion to follow. The introduction is not intended to limit or define any claimed or as yet unclaimed subject matter. One or more groups of claimed or unclaimed subject matter may reside in a combination or a sub-combination of the elements or process steps as described in any part of this document including its claims and figures.

In one broad aspect, at least one embodiment described herein provides a system for detecting a light spectrum of an input light beam. The system comprises an input configured to receive the input light beam; and a chain of detection stages coupled to one another in a branch-like fashion. Each detection stage is configured to detect a certain detection wavelength range of light where a first detection stage in the chain of detection stages is coupled to the input to receive the input light beam and a given detection stage that is upstream of a final detection stage in the chain of detection stages is configured to perform detection on a first portion of light having wavelengths within the detection wavelength of the given detection stage and to direct a second portion of light to a downstream detection stage, the directed light having wavelengths outside of the detection wavelength range of the given detection stage and wherein at least one of the detection stages comprises an optical element to provide branching and spectral subdivision.

In at least some embodiments, a given detection stage comprises a dispersive element configured to receive a given light beam and separate the given light beam into a first light beam and a second light beam having first and second wavelength ranges respectively; and a detector assembly coupled to the dispersive element to receive the first beam having the first wavelength range and being configured to detect light having wavelengths in the first wavelength range, the optical element also being configured to direct the second light beam to a downstream detection stage, wherein the first light beam is a dispersed light beam.

The second light beam may be an undispersed light beam.

Alternatively, the second light beam may be a dispersed light beam.

The first and second wavelength ranges of the first and second light beams may overlap by a certain desired amount or may not overlap.

In at least some embodiments, the given detection stage further comprises a focusing element coupled between the optical element and the detector assembly to focus and direct the first light beam to the detector assembly.

In at least some embodiments, the final detection stage may comprise a dispersive element configured to receive a given light beam and disperse the given light beam with a given wavelength range; and a detector assembly coupled to the dispersive element to receive the dispersed given light beam with the given wavelength range and being configured to detect light having wavelengths in the given wavelength range.

In at least some embodiments, the final detection stage further comprises a focusing element coupled between the dispersive element and the detector assembly to focus and direct the given light beam to the detector assembly.

In at least some embodiments, the dispersive element comprises a reflective element.

In at least some embodiments, the reflective element comprises a curved grating element which disperses and focuses the given light beam to the detector assembly.

In at least some embodiments, the dispersive element may comprise one of reflective or transmissive ruled diffraction gratings, reflective or transmissive holographic diffraction gratings, reflective or transmissive lithographic diffraction gratings, prism-grating combinations (grisms), and narrowly spaced wires.

In at least some embodiments, the detector assembly may comprise one or more of a CCD detector, a CMOS detector, an InGaAs detector, an MCT detector, photographic film, or other photosensitive detector system.

In at least some embodiments, the focusing element may comprise one of a concave mirror, a convex lens, a complex lens, and a combination of mirrors and lenses.

In at least some alternative embodiments, the given detection stage may comprise a dispersive element configured to receive a given light beam and separate the given light beam into three or more light beams having three or more wavelength ranges, at least one of the three or more light beams being a dispersed light beam; and one or more detector assemblies coupled to the dispersive element, each detector assembly receiving one or more dispersed light beams of the three or more light beams and being configured to detect light having wavelengths in the wavelength range of the received light beams, the dispersive element also being configured to direct one or more light beams of the three or more light beams that are not received by the one or more detector assemblies to one or more downstream detection stages.

In at least some embodiments, the at least one of the three or more separated light beams is a dispersed light beam or an undispersed light beam.

In at least some alternative embodiments, the final detection stage may comprise an optical element configured to receive a given light beam and split the given light beam into two or more light beams having two or more wavelength ranges; and one or more dispersive elements and detector assemblies coupled to the optical element to receive the two or more light beams, each dispersive element being configured to receive a split light beam and disperse it, and each detector assembly receiving one or more of the dispersed light beams and being configured to detect light having wavelengths in the wavelength range of the received light beams.

In at least some embodiments, the given detection stage may further comprise one or more additional dispersive elements to obtain higher-order diffracted light beams that are directed to the detector assembly to provide higher spectral resolution and better efficiency and the detector assembly is oriented at a different angle to receive the higher-order diffracted light beams.

In such embodiments, the focusing element is oriented at a different angle to receive and direct the higher-order diffracted light beams to the detector assembly.

In the various embodiments, the optical elements of the system may be implemented using free space optics components or integrated optics components.

In the various embodiments, the input light beam may comprise a collimated light beam.

In another broad aspect, at least one embodiment described herein provides a method of detecting a light spectrum of at least a portion of an input light beam, wherein the method comprises receiving the input light beam; splitting the input light beam using a first dispersive element into a first beam that is dispersed and has a first wavelength range and a second beam having a second wavelength range; performing light detection on the first beam at the first wavelength range using a first detector assembly; and performing the splitting and light detection acts on the second beam using additional dispersive elements and additional detector assemblies to detect light at additional wavelength ranges.

The second beam may be a dispersed light beam or an undispersed light beam.

The dispersive elements and the detector assemblies are generally arranged as a chain of detection stages that are coupled in a branch-like fashion with each detection stage being configured to detect a certain detection wavelength range of light and at least one of the detection stages has an optical element to provide both branching and spectral dispersion.

In at least some embodiments, the method further comprises receiving a given light beam; separating the given light beam into a first light beam that is dispersed and a second light beam, the first and second light beams having first and second wavelength ranges; detecting light from the first light beam having wavelengths in the first wavelength range; and directing the second light beam to a downstream detection stage.

In at least some embodiments, at a final detection stage, the method may further comprise receiving a given light beam, dispersing the given light beam with a given wavelength range; receiving the dispersed given light beam with the given wavelength range a detector assembly and detecting light having wavelengths in the given wavelength range.

In at least some embodiments, the method further comprises focusing and directing the first light beam to a given detector assembly of the given detection stage or the final detection stage.

In at least some embodiments, at a given detection stage, the method may further comprises receiving a given light beam; separating the given light beam into three or more light beams having three or more wavelength ranges; receiving one or more of the three or more light beams at one or more detector assemblies; detecting light having wavelengths in the wavelength range of the received light beams; and directing one or more of the three or more light beams that are not received at the one or more detector assemblies to one or more downstream detection stages.

In at least some embodiments, at a final detection stage, the method may further comprise receiving a given light beam; separating the given light beam into two or more light beams having two or more wavelength ranges; receiving one or more of the two or more light beams at one or more detector assemblies; and detecting light having wavelengths in the wavelength range of the received light beams.

In at least some embodiments, the method may further comprise using one or more additional dispersive elements to obtain higher-order diffracted light beams that are directed to the detector assembly to provide higher spectral resolution and better efficiency and the detector assembly is oriented at a different angle to receive the higher-order diffracted light beams.

In such embodiments, the method may further comprise orienting the focusing element at a different angle to receive and direct the higher-order diffracted light beams to the detector assembly.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 shows a block diagram of a general embodiment of a multi-backend system that has multiple detection stages;

FIG. 2 shows a block diagram of an example embodiment of a multi-backend system for use with a spectrometer or another device that requires light to be dispersed over a wide bandwidth; and

FIG. 3 shows a flowchart of an example embodiment of a multi-stage light detection method.

### DETAILED DESCRIPTION OF THE EMBODIMENTS

Various apparatuses or processes will be described below to provide at least one example of an embodiment of the claimed subject matter. No embodiment described below limits any claimed subject matter and any claimed subject matter may cover processes or apparatuses that differ from those described below. The claimed subject matter are not limited to apparatuses or processes having all of the features of any one apparatus or process described below or to features common to multiple or all of the apparatuses or processes described below. It is possible that an apparatus or process described below is not an embodiment of any claimed subject matter. Any subject matter disclosed in an apparatus or process described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms “coupled” or “coupling” can have a mechanical, an electrical or an optical connotation. For example, as used herein, the terms “coupled” or “coupling” indicate that two elements or devices can be directly connected to one another or connected to one another through one or more intermediate elements or devices via an optical connection through free space, fiber optic cable, or waveguide.

It should also be noted that the term “dispersed beam” as used herein refers to a spectrally dispersed light beam such as, but not limited to, a light beam that is diffracted into a range of angles dependent upon wavelength by an optical element such as, but not limited to, a reflective or transmissive diffraction grating, an array of narrowly-spaced wires, or a diffraction grating combined with a prism (collectively known as a grism).

It should also be noted that use of the term “direct” or “directed” when describing what an optical element in an optical system does with light or a light beam herein means that the optical element may change the direction of at least a portion of the light or light beam or the optical element may just allow at least a portion of the light beam to pass through it en route to another portion of the optical system.

It should also be noted that terms of degree such as “about”, “substantially”, and “approximately” as used herein mean a reasonable amount of deviation of the modified term such that the end result is not significantly changed. These terms of degree should be construed as including an acceptable deviation of the modified term if this deviation would not negate the meaning of the term it modifies.

It should also be noted that the term ‘wavelength range’ is used herein to refer to a specific range of wavelength values and the term ‘bandwidth’ is used herein to refer to the size of the wavelength range.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about”. The term “about” means an acceptable deviation of the number to which reference is being made without negating the result that corresponds with the number.

Furthermore, in the following passages, different aspects of the embodiments are defined in more detail. Each aspect so defined may be combined with any other aspect or aspects unless clearly indicated to the contrary. In particular, any feature indicated as being preferred or advantageous may be combined with at least one other feature or features indicated as being preferred or advantageous.

Described herein are various example embodiments of a system and method that can be used for obtaining large bandwidth, high resolution spectral images in a single snapshot, without scanning or swapping of components as described in the background. It is possible to achieve this with multiple dispersive and detector elements arranged with different detection stages that are optimized for different light wavelength ranges and are coupled in a branch-like fashion. An aspect of the embodiments described herein is that a single input beam may be split multiple times by use of the dispersive elements themselves rather than conventional beam splitting devices such as dichroic filters. Both of these techniques can be used in spectroscopic devices and have various applications such as, but not limited to, atomic emission spectroscopy, atomic absorption spectroscopy, spectrophotometry, and laser-induced breakdown spectroscopy (LIBS).

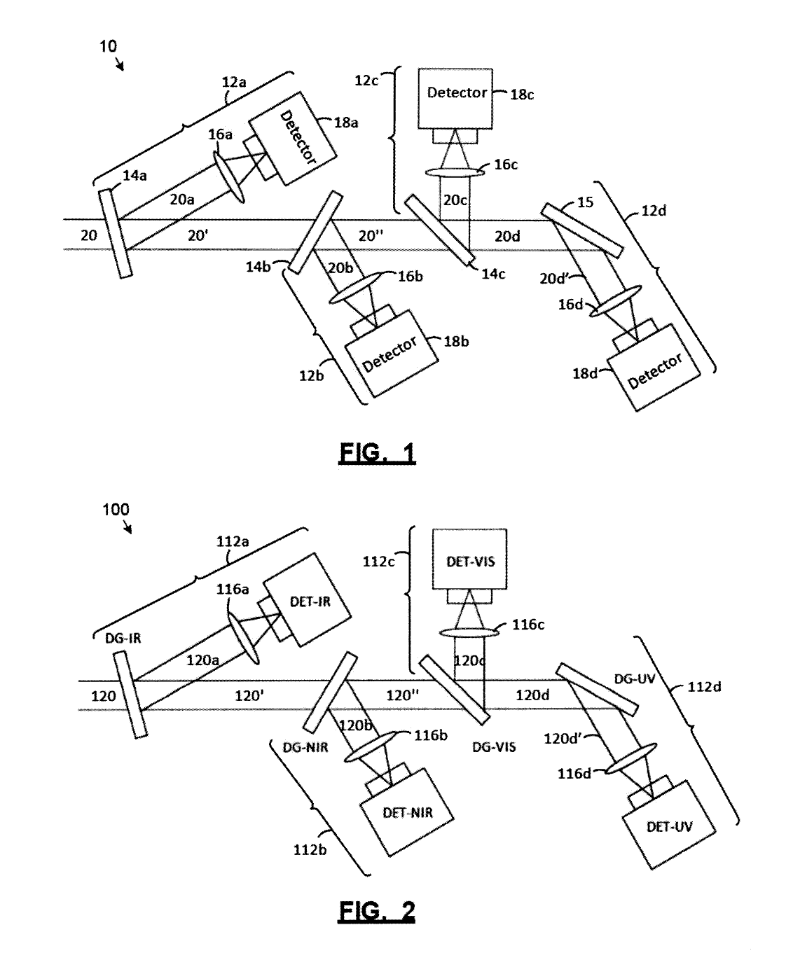

Referring now to FIG. 1, shown therein is a block diagram of a general embodiment of a multi-backend system 10 that has multiple detection stages. It should be noted that the term “backend” refers to the section of a spectrometer system which disperses, detects, and measures the spectral energy distribution of an incident light beam. A spectroscopic backend may include, but is not limited to, a dispersive element (such as, but not limited to, a transmissive or reflective diffraction grating, a prism, a grid of wires, or a combined diffraction grating and prism), a focusing element (a simple lens, a complex lens, or one or more curved mirrors), and a detector (such as, but not limited to, a CCD array, a CMOS array, an InGaAs array, or an MCT array). By way of example, many conventional spectrometer systems have a single backend following the input aperture and collimator, but in contrast and according to the teachings herein, example embodiments of spectrometer systems are taught having multiple backends all sharing a single input aperture and collimator. The use of multiple backends and dispersive elements as taught herein results in greater resolution for data analysis, fewer optical components, lower cost and increased robustness.

The multi-backend system 10 comprises several detection stages 12a to 12d that are optically coupled in a branch-like fashion with one another and are configured to receive and detect certain wavelength ranges of a broadband input light beam. The detection stages 12a to 12c each generally have a dispersive element 14a to 14c, a focusing element 16a to 16c and a detection assembly 18a to 18c. In this example embodiment, the dispersive element of the final detection stage 12d comprises a reflective dispersive element 15 and the dispersive elements 14a to 14c are transmissive dispersive elements. The detection stage 12d also comprises a focusing element 16d and a detection assembly 18d.

However, in alternative embodiments the transmissive dispersive elements 14a to 14c may instead be reflective dispersive elements and the reflective dispersive element 15 may instead be a transmissive dispersive element.

In other embodiments, the dispersive elements 14a to 14c and 15 may be reflective for some wavelengths and transmissive for others, for example by using a narrow-band reflective coating.

The dispersive elements 14a to 14c and 15 can be, but are not limited to, ruled diffraction gratings (reflective or transmissive), holographic diffraction gratings (reflective or transmissive), reflective or transmissive lithographic diffraction gratings, prism-grating combinations (grisms), narrowly spaced wires, and the like. The focusing elements 16a to 16d can be, but are not limited to, a concave mirror, a convex lens, a complex lens, a combination of mirrors and lenses, and the like. The detector assemblies 18a to 18d can be, but are not limited to, CCD detectors, CMOS detectors, InGaAs detectors, MCT detectors, photographic film, or other photosensitive detector system. In some cases, it may even be possible that the detector assemblies 16a to 16d may be an eye directly observing the light. Any of the above elements can be combined with each other for any detection stage of the backend systems described herein.

In some alternative embodiments, the focusing elements 16a to 16d are not used, such as in some cases where the light beams are small enough such that they do not require focusing.

The multi-backend system 10 provides spectra with a large bandwidth and a high spectral resolution by using the stages 12a to 12d arranged in a branch-like fashion and carefully selecting the wavelength ranges of the dispersive elements 14a to 14c and 15, and the detector assemblies 18a to 18d. The wavelength ranges of the detectors 18a to 18d correspond to the wavelength ranges of the light beam that is directed to the detector assemblies 18a to 18d from the dispersive elements 14a to 14c and 15, respectively. The complete ultra-broadband spectrum comprises the concatenation of the individual spectra provided by each of the branches 12a through 12d.

In this example embodiment, the dispersive elements 14a to 14c are transmissive diffraction gratings which are used to diffract light within a certain wavelength range, dependent upon the specific design and manufacture of the grating, while most or all of the out-of-band light remains in the undispersed “zero^{th} order” beam that passes straight through the grating with approximately zero angular deviation. In general, the multi-backend system 10 is designed such that the “zero^{th} order” beam from one diffraction grating coincides with the in-band light of one or more subsequent or downstream diffraction gratings, and so on. This structure can be repeated numerous times depending on the total input bandwidth and the desired amount of output spectral dispersion (i.e. output resolution). The final stage 12d may be designed to provide a single light beam as shown in FIG. 1 although in other embodiments, the final stage 12d may generate two or more light beams having different bandpasses for detection by different detector assemblies.

The multi-backend system 10 uses the dispersive elements 14a to 14c to achieve both the branching and spectral subdivision, rather than using beam splitters such as dichroic filters. Accordingly, the multi-backend system 10 advantageously uses fewer elements so that it is reduced in complexity and cost, and the throughput efficiency is increased because all of the light in the zero^{th} order beams is used.

In FIG. 1, the multi-backend system 10 receives a broadband input light beam 20 via an input. The input light beam 20 travels from left to right and has a first wavelength range. The light beam 20 first encounters the detection stage 12a in which the dispersive element 14a, for example a diffraction grating, splits the light beam 20 into a dispersed light beam 20a having a second wavelength range and a light beam 20′ having a third wavelength range. The light beam 20a is directed towards the detector assembly 18a via the focusing element 16a which focuses the light beam 20a. The light beam 20′ is directed to the subsequent downstream detection stage 12b. The second and third wavelength ranges are each a subset of the first wavelength range and make up all or a portion of the first wavelength range. The detector assembly 18a collects the dispersed light beam 20a and generates data measuring the spectral components of the light beam 20 within the second wavelength range.

The light beam 20′ then encounters the detection stage 12b in which the dispersive element 14b splits the light beam 20′ into a dispersed light beam 20b having a fourth wavelength range and a light beam 20″ having a fifth wavelength range. The light beam 20b is focused by the focusing element 16b and then directed to the detector assembly 18b. The light beam 20″ is directed to the subsequent downstream detection stage 12c. The fourth and fifth wavelength ranges make up all or a portion of the third wavelength range. The detector assembly 18b collects the dispersed light beam 20b and generates data measuring the spectral components of the light beam 20b in the fourth wavelength range.

The light beam 20″ travels to the next detection stage 12c in which the dispersive element 14c splits the light beam 20″ into a dispersed light beam 20c having a sixth wavelength range and a light beam 20d having a seventh wavelength range. The light beam 20c is directed towards the detector assembly 18c via the focusing element 16c and the light beam 20d is directed to the subsequent downstream detection stage 12d. The sixth and seventh wavelength ranges make up all or a portion of the fifth wavelength range. The detector assembly 18c collects the dispersed light beam 20c and generates data measuring the spectral components of the light beam 20c in the sixth wavelength range.

The light beam 20d is directed to the detection stage 12d which has a dispersive element 15, for example a reflection grating, which is optimized for the seventh wavelength range of the light beam 20. The dispersed light beam 20d′ is focused by the focusing element 16d and collected by the detector assembly 18d which then generates data measuring the spectral components of the light beam 20 in the seventh wavelength range. In alternative embodiments, a transmission grating may be used instead of the reflection grating.

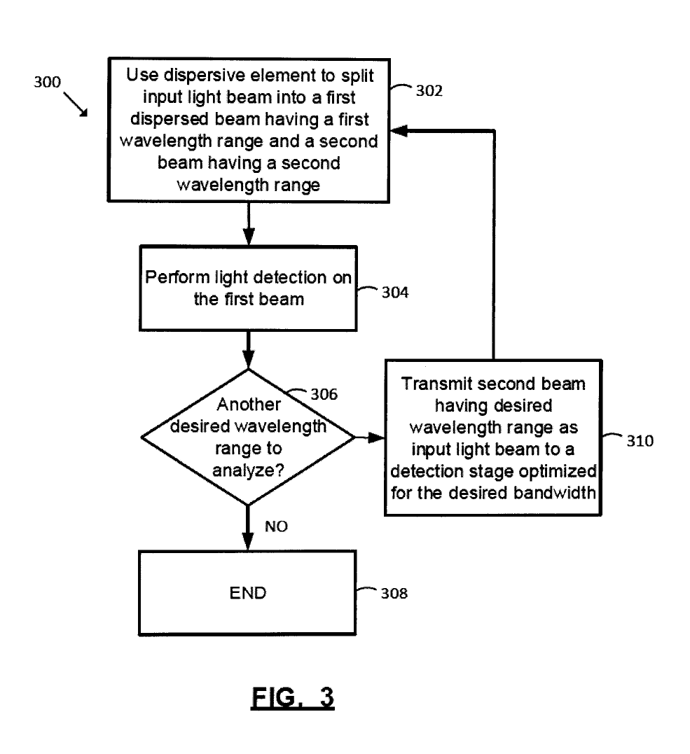

Referring now to FIG. 2, shown therein is a block diagram of another example embodiment of a multi-backend system 100 for use with a spectrometer or another device that requires light to be dispersed over a wide bandwidth. The multi-backend system 100 receives a broadband light beam 120 travelling from left to right and having a bandwidth that extends from infrared wavelengths to ultraviolet wavelengths. The light beam 120 first encounters the detection stage 112a and is split by an infrared optimized transmission grating DG-IR into a dispersed light beam 120a that has an infrared wavelength range only and is directed towards the detector assembly DET-IR and an undispersed light beam 120′ that has the remaining wavelength range of the light beam 120 and is directed to a subsequent downstream detection stage 112b. In this example embodiment, the dispersion is due to diffraction. For example, the transmission grating DG-IR can be configured to diffract the portion of the light beam 120 having wavelengths from 1.7 μm to 1.1 μm towards the detector assembly DET-IR and direct the portion of the light beam 120 having wavelengths shorter than 1.1 μm to the subsequent detection stages. The detector assembly DET-IR includes an infrared detector that collects the diffracted infrared light beam 20a and generates data measuring the spectrum of the 1.1 to 1.7 μm region.

The light beam 120′ then encounters the detection stage 112b which comprises a near-infrared optimized diffraction grating DG-NIR that behaves in a similar manner to the diffraction grating DG-IR over a shorter-wavelength regime, e.g. it splits the light beam 120′ into a dispersed light beam 120b having light between 1.1 μm and 700 nm, and directs an undispersed light beam 120″ having light with wavelengths shorter than 700 nm to the downstream detection stage 112c. The near infrared light beam 120b is collected by the detector assembly DET-NIR which then generates data measuring the spectrum of the 1.1 μm to 700 nm region.

The light beam 120″ travels to the next detection stage 112c which has a transmission diffraction grating DG-VIS that is optimized for the visible spectrum (i.e. 700 nm to 400 nm). The diffraction grating DG-VIS splits the light beam 120″ into a dispersed visible light beam 120c that is directed towards a visible light detector assembly DET-VIS and directs an undispersed light beam 120d to the detection stage 112d and only contains wavelengths shorter than 400 nm since all the other upstream diffraction gratings diffracted the longer wavelengths. The dispersed visible light beam 120c is collected by the detector assembly DET-VIS which then generates data measuring the spectrum of the 700 nm to 400 nm region.

The light beam 120d is directed to the detection stage 112d with a reflection grating DG-UV that is optimized for ultraviolet light. Accordingly, the reflection grating DG-UV disperses light with wavelengths shorter than 400 nm to the detector assembly DET-UV which is optimized for ultraviolet light. The dispersed light beam 120d′ is collected by the detector assembly DET-UV which then generates data measuring the spectrum of the sub-400 nm region.

Referring now to FIG. 3, shown therein is a flowchart of an example embodiment of a multi-stage light detection method 300. At 302, an input light beam is processed at a detection stage optimized for a desired wavelength range by using a dispersive element to split the input light beam into a dispersed first beam and an undispersed second beam having first and second wavelength ranges that make up all or a portion of the wavelength ranges of the input light beam. The first beam having the first wavelength range coincides with the desired wavelength range. At 304, light detection is performed on the first beam having the desired wavelength range for which the detection stage is optimized. At 306, if there is an additional desired wavelength range to be analyzed that is within the bandpass of the second light beam then at 310 the second light beam is directed to a detection stage that is optimized for this additional desired wavelength range and acts 302 and 304 can be performed in a likewise fashion for this additional desired wavelength range using a detection stage that is optimized for this additional desired wavelength range. Additional stages preferably use dispersive splitting but may use other forms of beam splitting in alternative embodiments. Otherwise, if there is no other additional desired wavelength ranges to be analyzed at 306 then the method 300 ends at 308.

It should be noted that at least some of the embodiments of the multi backend systems described herein provide the ability to simultaneously acquire spectra from the different dispersive elements that are used which allows for use in high-speed applications. This is in contrast to systems which use a rotating turret that can only provide for a single measurement or a single narrow bandpass at a time and therefore cannot be used in high-speed applications.

It should be noted that there are many other configurations of multi-backend systems according to the teachings herein that are possible. For example, other embodiments can have a different number of detection stages and different types of wavelength ranges for each detection stage.

It should also be noted that in some embodiments, a given dispersive element can be configured such that the dispersed and undispersed beams from the given dispersive element have wavelength ranges that overlap by a certain desired amount. Alternatively, in other embodiments, the dispersive element can be configured such that the dispersed and undispersed beams from the given dispersive element have wavelength ranges that do not overlap (as was shown in the example of FIG. 2).

In alternative embodiments, the sequence of the wavelength ranges for the detection stages can be different (e.g. in the example shown in FIG. 2, the detection stage for visible light may be upstream of the detection stage for near infrared light).

In other alternative embodiments, reflection or transmission gratings may be used in each detection stage. In the case of a reflection grating, the zero^{th}-order undispersed beam will be reflected at an angle as if the grating were a mirror, while the dispersed beam will be diffracted at a different angle. The subsequent stages of the multi-backend spectrometer device can be placed to receive this reflected but undispersed zero^{th}-order beam, in a fashion analogous to the transmitted undispersed beam from a transmission grating as described in the example embodiments above (e.g. 20′, 20″, etc. from FIG. 1).

In other alternative embodiments, there can be different physical orientations of the gratings and detector assemblies. For instance, a dispersed beam may be directed to the left or right of the transmitted or reflected zero^{th}-order beam, or up or down (out of the plane of FIGS. 1 and 2), or at an intermediate diagonal angle.

In other alternative embodiments, higher-order diffracted beams (e.g. the 2^{nd} order, the 3^{rd} order, the 4^{th} order, etc.) may be obtained from one or more gratings and sent to a detector assembly in addition to or instead of just the first-order diffracted beam (as is the case for the multi-backend systems 10 and 100). These higher-order beams can provide higher spectral resolution and better efficiency, depending on the design and characteristics of the dispersive grating. To receive the higher-order diffracted beams, the focusing optics and detector assembly for each branch (i.e. detection stage) are oriented at a different angle than for the corresponding first-order beam, but the functionality of each stage is otherwise equivalent.

In other alternative embodiments, it should be noted that at least one of the detection stages comprises a dispersive element that can split an input light beam into three or more light beams having particular wavelength ranges. In some embodiments, the dispersive element is configured such that the three or more light beams have wavelength ranges that do not overlap. In some embodiments, the dispersive element is configured such that the three or more light beams have wavelength ranges that overlap by a certain amount, such as 5% for example.

It should be noted that in the embodiments in which a dispersive element produces three or more light beams, the detection stage can include more than one detector assembly in which case each detector assembly receives one or more of the light beams from the dispersive element and is configured to detect light having wavelengths in the wavelength range of the light beams that are received.

In other alternative embodiments, a given branch may be further split into two or more sub-branches by placing an additional dispersive element into the dispersed beam received by the given branch. The geometry of the complete system would then resemble a “binary tree” with branches and sub-branches and sub-sub-branches, rather than just a central “trunk” with single branches attached thereto.

In other alternative embodiments, the multi-grating concept could also be combined with conventional dichroic filters and beamsplitters, in circumstances where that combination would be advantageous. For example, if the efficiency of a grating is low and would block too much light from the next detection stage, it may be better to use a conventional dichroic beamsplitter. Also, if a particular stage only needed to be measured in intensity instead of spectral content, a conventional beamsplitter may be used in place of a grating.

It should be noted that in some embodiments, the input light beam 20 may comprise a collimated light beam.

It should be noted that in alternative embodiments, the final detection stage may use conventional beam splitting to generate split beams and then a dispersive element and a detector assembly that operate on each of the split beams.

It should be noted that in alternative embodiments, a mix of dispersive beam splitting and conventional beam splitting may be used in the various detection stages for a given system. Accordingly, in such alternative embodiments, there is at least one of detection stages having an optical element that provides both branching and spectral dispersion.

It should be noted that while the embodiments of the multi-backend system described herein are designed using free-space optics components, there can be alternative embodiments in which a multi-backend system is implemented using integrated optics. In this case, the focusing elements are not needed if integrated optic waveguides can be directly coupled to the detector assemblies.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without generally departing from the scope of the embodiments described herein, which is limited only by the appended claims which should be given the broadest interpretation consistent with the description as a whole.

1. A system for detecting a light spectrum, wherein the system comprises:
an input configured to receive an input light beam; and
a chain of detection stages coupled to one another in a branch-like fashion, each detection stage being configured to detect a dispersed spectrum over a certain detection wavelength range of light where a first detection stage in the chain of detection stages is coupled to the input to receive the input light beam and at least one given detection stage that is upstream of a final detection stage in the chain of detection stages is configured to perform detection on a first portion of dispersed light having wavelengths within the detection wavelength range of the at least one given detection stage and to direct a second portion of undispersed light to a downstream detection stage, the directed light having wavelengths outside of the detection wavelength range of the at least one given detection stage and wherein the at least one given detection stage comprises an optical element to receive a given light beam and separate the given light beam into the first portion of dispersed light and the second portion of undispersed light having different first and second wavelength ranges respectively.

2. The system of claim 1, wherein the given detection stage comprises:
a dispersive element as the optical element to receive the given light beam and separate the given light beam into the first dispersed light beam and the second undispersed light beam having first and second wavelength ranges respectively; and
a detector assembly coupled to the dispersive element to receive the first dispersed light beam having the first wavelength range and being configured to detect the dispersed spectrum of light having wavelengths in the first wavelength range,
the dispersive element also being configured to direct the second undispersed light beam to a downstream detection stage.

3. The system of claim 1, wherein every detection stage upstream of the final detection stage has the same structure as the given detection stage.

4. The system of claim 2, wherein the given detection stage further comprises a focusing element coupled between the optical element and the detector assembly to focus and direct the first dispersed light beam to the detector assembly.

5. The system of claim 1, wherein the final detection stage comprises:
a dispersive element configured to receive a final light beam and disperse the final light beam with a final wavelength range; and
a detector assembly coupled to the dispersive element to receive the dispersed final light beam with the final wavelength range and being configured to detect light having wavelengths in the final wavelength range.

6. The system of claim 5, wherein the final detection stage further comprises a focusing element coupled between the dispersive element and the detector assembly to focus and direct the final light beam to the detector assembly.

7. The system of claim 5, wherein the dispersive element of the final detection stage comprises a reflective element.

8. The system of claim 7, wherein the reflective element comprises a curved grating element which disperses and focuses the final light beam to the detector assembly.

9. The system of claim 2, wherein the dispersive element comprises one of reflective or transmissive ruled diffraction gratings, reflective or transmissive holographic diffraction gratings, reflective or transmissive lithographic diffraction gratings, prism-grating combinations (grisms), and narrowly spaced wires.

10. The system of claim 2, wherein the detector assembly comprises one or more of a CCD detector, a CMOS detector, an InGaAs detector, an MCT detector, photographic film, or other photosensitive detector system.

11. The system of claim 4, wherein the focusing element comprises one of a concave mirror, a convex lens, a complex lens, and a combination of mirrors and lenses.

12. The system of claim 1, wherein the given detection stage comprises:
a dispersive element as the optical element to receive the given light beam and separate the given light beam into three or more light beams having three or more wavelength ranges, at least one of the three or more light beams being a dispersed light beam; and
one or more detector assemblies coupled to the dispersive element, each detector assembly receiving one or more dispersed light beams of the three or more light beams and being configured to detect light having wavelengths in the wavelength range of the received light beams,
the dispersive element also directing one or more light beams of the three or more light beams that are not received by the one or more detector assemblies to one or more downstream detection stages as undispersed light beams.

13. (canceled)

14. The system of claim 2, wherein first and second wavelength ranges of the first portion of dispersed light beam and the second portion of undispersed light beam overlap by a certain desired amount or do not overlap.

15. The system of claim 2, wherein the given detection stage further comprises one or more additional dispersive elements to obtain higher-order diffracted light beams that are directed to the detector assembly to provide higher spectral resolution and better efficiency and the detector assembly is oriented at a different angle to receive the higher-order diffracted light beams.

16. The system of claim 15 wherein the given detection stage further comprises at least one focusing element coupled between at least one of the dispersive elements and the detector assembly to focus and direct at least one dispersed light beam to the detector assembly, wherein the at least one focusing element is oriented at a different angle to receive and direct the higher-order diffracted light beams to the detector assembly.

17. The system of claim 1, wherein optical elements of the system are implemented using free space optics components or integrated optics components.

18. The system of claim 1 wherein the input light beam comprises a collimated light beam.

19. A method of detecting a light spectrum of at least a portion of an input light beam, wherein the method comprises:
receiving the input light beam;
separating the input light beam using a first dispersive element into a first beam that is dispersed and has a first wavelength range and a second undispersed beam having a second wavelength range;
performing light detection on the first beam at the first wavelength range using a first detector assembly; and
performing the splitting and light detection acts on the second undispersed beam using additional dispersive elements and additional detector assemblies to detect light at additional wavelength ranges.

20. The method of claim 19, wherein the dispersive elements and the detector assemblies are arranged as a chain of detection stages that are coupled in a branch-like fashion with each detection stage being configured to detect a certain detection wavelength range of light and at least one of the detection stages has an optical element to provide both branching and spectral dispersion.

21. The method of claim 20, wherein at a given detection stage, the method further comprises:
receiving a given light beam;
separating the given light beam into a first light beam that is dispersed and a second undispersed light beam, the first and second light beams having first and second wavelength ranges;
detecting light from the first light beam having wavelengths in the first wavelength range; and
directing the second light beam to a downstream detection stage.

22. The method of claim 21, wherein every detection stage upstream of a final detection stage has the same structure as the given detection stage.

23. The method of claim 21, wherein the method further comprises focusing and directing the first light beam to a given detector assembly of the given detection stage.

24. The method of claim 21, wherein the first and second wavelength ranges of the first light beam and the second undispersed light beam overlap by a certain desired amount or do not overlap.

25. The method of claim 20, wherein at a given detection stage, the method further comprises:
receiving a given light beam;
separating the given light beam into three or more light beams having three or more wavelength ranges with at least one of the separated light beams being a dispersed light beam and at least one of the separated light beams being an undispersed light beam;
receiving the dispersed light beams at one or more detector assemblies;
detecting light having wavelengths in the wavelength range of the received light beams; and
directing the undispersed light beams to one or more downstream detection stages.

26. The method of claim 23, wherein the method further comprises using one or more additional dispersive elements to obtain higher-order diffracted light beams that are directed to the given detector assembly to provide higher spectral resolution and better efficiency and the given detector assembly is oriented at a different angle to receive the higher-order diffracted light beams.

27. The method of claim 26, wherein the method further comprising orienting the focusing element at a different angle to receive and direct the higher-order diffracted light beams to the detector assembly.
